(19) United States
(12) Patent Application Publication
(10) Pub. No.: US 2020/0301059 A1
(43) Pub. Date: Sep. 24, 2020

(54) A CUTTING ELEMENT FOR USE IN A HAIR CUTTING DEVICE, AND A METHOD OF MANUFACTURING THE SAME

(71) Applicant: KONINKLIJKE PHILIPS N.V., EINDHOVEN (NL)

(72) Inventors: YANNYK PARULIAN JULIAN BOURQUIN, EINDHOVEN (NL); JOSEPH PETRUS HENRICUS TER BORCH, EINDHOVEN (NL); PETRUS THEODORUS JUTTE, EINDHOVEN (NL); KIRAN KUMAR THUMMA, EINDHOVEN (NL); BASTIAAN WILHELMUS MARIA MOESKOPS, EINDHOVEN (NL); RIEKO VERHAGEN, EINDHOVEN (NL); MARK THOMAS JOHNSON, EINDHOVEN (NL)

(21) Appl. No.: 16/088,091

(22) PCT Filed: Mar. 22, 2017
(86) PCT No.: PCT/EP2017/056775

§ 371 Date: Sep. 25, 2018

(30) Foreign Application Priority Data
Mar. 29, 2016 (EP) 16162687.4

(51) Int. Cl. F21V 8/00; C03B 37/012; A45D 26/00; G02B 6/02; G02B 6/25; B26B 21/40; B26B 21/48; G02B 6/28

(52) U.S. Cl. CPC G02B 6/001; C03B 37/01234; A45D 26/0009; G02B 6/02; C03B 2203/02; B26B 21/4081; B26B 21/48; G02B 6/2826; G02B 6/25

(57) ABSTRACT

There is provided a method of manufacturing a cutting element for use in a hair cutting device, the cutting element comprising an optical waveguide, the method comprising providing a preform for an optical waveguide, the preform comprising a core and an outer layer, wherein the outer layer is arranged around the core along the length of the core; forming a shaped preform by removing a portion of the outer layer along the length of the core to expose part of the core, wherein a remaining portion of the outer layer is a support structure for the core; heating the shaped preform; and pulling the shaped preform in the direction of the axis of the core to reduce the cross-section of the shaped preform and form the optical waveguide. Also provided is a cutting element manufactured according to the above method and a cutting element for use in a hair cutting device, the cutting element comprising an optical waveguide comprising a core and a support structure, wherein the support structure contacts the core along the length of the core to support the core, and wherein part of the core is exposed along the length of the core to form a cutting face for contacting hair. The thickness of the support structure tapers linearly or non-linearly from a thin side at which the support structure contacts the core to a thick side.

### FIELD OF THE INVENTION

The invention relates to a cutting element for use in a hair cutting device, and a method of manufacturing the same, and in particular to a cutting element that comprises an optical waveguide.

### BACKGROUND OF THE INVENTION

Shaving devices for cutting or shaving hair on a body of a subject typically make use of one or more blades that cut hairs as the blade is moved across the skin of the subject. The blades can be static within the device, for example as in a wet razor, whereas in other types of devices, for example electric shavers, one or more blade elements can be actuated (e.g. rotated or oscillated) in order to produce a cutting action.

However, an alternative type of shaving device has been proposed in WO 2014/143670 that makes use of laser light. In particular a laser light source is provided that is configured to generate laser light having a wavelength selected to target a predetermined chromophore to effectively cut a hair shaft. A fiber optic is located on a shaving portion of the device that is positioned to receive the laser light from the laser light source at a proximal end, conduct the laser light from the proximal end toward a distal end, and emit the light out of a cutting region of the fiber optic and toward hair when the cutting region is brought in contact with the hair. The cladding of the fiber optic can be reduced or removed in some part of the fiber optic to form the cutting region.

It is to be noted that US patent application publication US 2002/0172459 A1 discloses a method to manufacture an optical waveguide from a D-shaped preform, resulting in an optical waveguide having a D-shape as well.

### SUMMARY OF THE INVENTION

A fiber optic with reduced or removed cladding as described above will be extremely fragile and not able to sustain typical mechanical forces arising due to the contact of the fiber optic on the skin and hair of a subject. As such, the fiber optic is likely to break or otherwise be damaged during use and require replacement.

The fiber optic in the above-mentioned shaving device can have a D-shape, which means that coupling light into a hair is difficult as the hair needs to be in contact with the small portion of the exposed core, which reduces the effectiveness of the shaving device. Moreover, it is difficult to process fiber optics to obtain the required D-shape due to the high precision required and the fragility of the fiber optic.

Therefore there is a need for an improved cutting element for use in a hair cutting device, and an improved method of manufacturing a cutting element.

According to a first aspect, there is provided a method of manufacturing a cutting element for use in a hair cutting device, the cutting element comprising an optical waveguide, the method comprising providing a preform for an optical waveguide, the preform comprising a core and an outer layer, wherein the outer layer is arranged around the core along the length of the core; forming a shaped preform by removing a portion of the outer layer along the length of the core to expose part of the core, wherein a remaining portion of the outer layer is a support structure for the core; heating the shaped preform; and pulling the shaped preform in the direction of the axis of the core to reduce the cross-section of the shaped preform and form the optical waveguide. The thickness of the support structure tapers linearly or non-linearly from a thin side at which the support structure contacts the core to a thick side.

In some embodiments, the step of forming the shaped preform comprises grinding or polishing the preform to remove the portion of the outer layer.

In some embodiments, the thickness of the support structure tapers such that the support structure is wedge-shaped, and wherein the core is along an apex edge of the support structure.

In some embodiments, the thickness of the support structure tapers such that the support structure is V-shaped, and wherein the core is at the apex of the V-shaped support structure.

In some embodiments, the step of forming the shaped preform comprises removing the portion of the outer layer along the length of the core such that a predetermined amount of the circumference of the core is exposed along the length of the core. In some embodiments, the predetermined amount of the circumference of the core is more than 20%, optionally more than 30%, optionally more preferably more than 40% or optionally preferably more than 50%.

In some embodiments, the method further comprises the step of shaping the support structure to enable attachment of the cutting element to, and/or alignment of the cutting element with, a hair cutting device.

In some embodiments, the step of shaping the support structure comprises shaping the support structure to comprise one or more protrusions and/or indentations.

In some embodiments, the step of shaping the support structure to enable attachment of the cutting element to, and/or alignment of the cutting element with, a hair cutting device is performed before or after the steps of heating the shaped preform and pulling the shaped preform.

In some embodiments, the core comprises a first material and the support structure comprises a second material, wherein the first material has a higher refractive index than the second material.

According to a second aspect, there is provided a cutting element for use in a hair cutting device, the cutting element comprising an optical waveguide comprising a core and a support structure, wherein the support structure contacts the core along the length of the core to support the core, and wherein part of the core is exposed along the length of the core to form a cutting face for contacting hair.

In some embodiments, the thickness of the support structure tapers linearly or non-linearly from a thin side at which the support structure contacts the core to a thick side.

In some embodiments, the support structure is wedge-shaped and the core is at an apex edge of the support structure.

In some embodiments, the support structure is V-shaped and the core is at the apex of the V-shape.

In some embodiments, a predetermined amount of the circumference of the core is exposed to form the cutting face along the length of the core. In some embodiments, the predetermined amount of the circumference of the core is more than 20%, optionally more than 30%, optionally more preferably more than 40% or optionally preferably more than 50%.

In some embodiments, the support structure is shaped to receive, or be received in, a part of a hair cutting device.

In some embodiments, the support structure is shaped to enable attachment of the cutting element to, and/or alignment of the cutting element with, a hair cutting device. In some embodiments, the support structure comprises one or more protrusions and/or indentations for enabling attachment of the cutting element to, and/or alignment of the cutting element with, a hair cutting device.

In some embodiments, the core comprises a first material and the support structure comprises a second material, wherein the first material has a higher refractive index than the second material.

According to a third aspect, there is provided a cutting element for use in a hair cutting device manufactured according to any of the methods described above.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 is a block diagram of a hair cutting device in which a cutting element according to an embodiment of the invention can be used;

FIG. 2 is a pair of schematic drawings showing different views of an exemplary hair cutting device;

FIG. 3 is an illustration of a cutting element according to a first embodiment;

FIG. 4 is an illustration of a cutting element according to a second embodiment;

FIG. 5 illustrates the coupling of the cutting element to a light source of a hair cutting device;

FIG. 6 shows a coupling between a core of a cutting element and the light source in more detail;

FIG. 7 is a flow chart illustrating a method of manufacturing a cutting element according to an embodiment; and

FIG. 8 illustrates the stages of the method of FIG. 7.

### DETAILED DESCRIPTION OF THE EMBODIMENTS

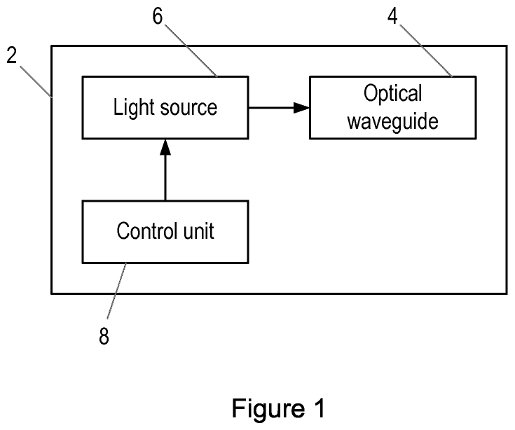

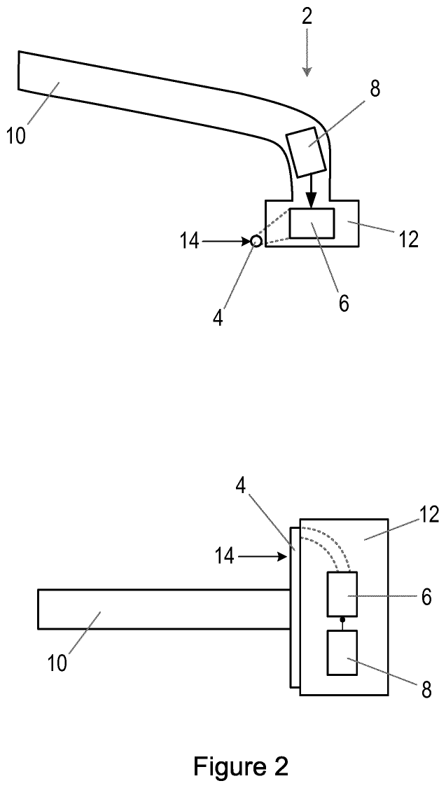

As noted above, the present invention provides improvements in cutting elements and manufacturing methods thereof for use in hair cutting devices in which light is coupled to hair. FIGS. 1 and 2 illustrate exemplary hair cutting devices in which the cutting elements according to the invention can be used.

It will be appreciated that the invention is applicable to cutting elements for shaving devices (e.g. razors or electric shavers), and any other type of device that is used to cut hair (e.g. hair clippers), even if those devices do not necessarily aim to provide a ‘clean shave’ (i.e. to remove hair at the level of the skin).

FIG. 1 is a block diagram of an exemplary hair cutting device 2. FIG. 2 shows a hair cutting device 2 in the form of a handheld razor. The hair cutting device 2 is for cutting (e.g. shaving) hair on a body of a subject. The subject may be a person or an animal. The hair may be facial hair (i.e. hair on the subject's face), or hair on the subject's head or other part of their body (legs, chest, etc.).

The hair cutting device 2 comprises a cutting element 4 that enables hair to be cut as the hair cutting device 2 is moved over the skin of a subject. The cutting element 4 is an optical waveguide 4 that is arranged on the hair cutting device 2 so that the optical axis of the optical waveguide 4 (i.e. the line along which light typically propagates through the optical waveguide 4) is generally perpendicular to the direction in which the hair cutting device 2 is moved so that hairs contact the side wall of the optical waveguide 4 (the side wall corresponding to the long edge of the optical waveguide 4) as the hair cutting device 2 is moved across the skin of the subject. In some embodiments, the optical waveguide 4 is an optical fibre, although those skilled in the art will be aware of other types of optical waveguide that can be used according to the invention, such as a slab waveguide, a strip waveguide or a photonic crystal waveguide. The optical waveguide comprises a core, and also an outer layer, e.g. a cladding, which partly encompasses the core (i.e. part of the core is exposed).

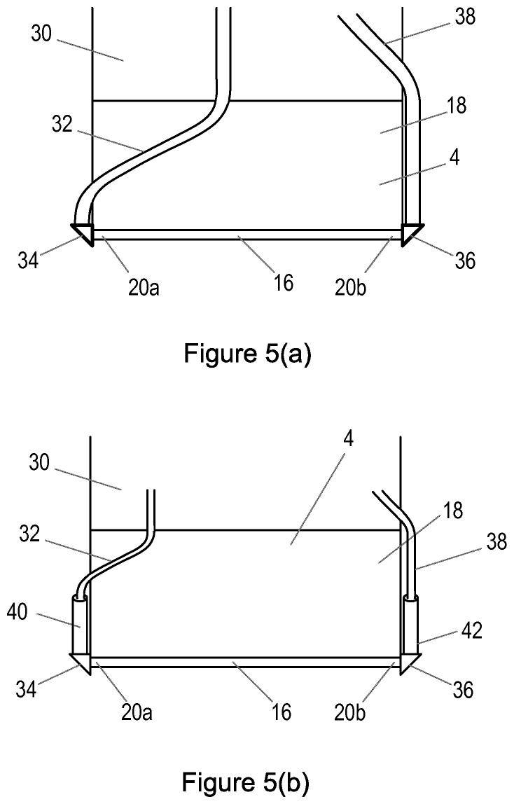

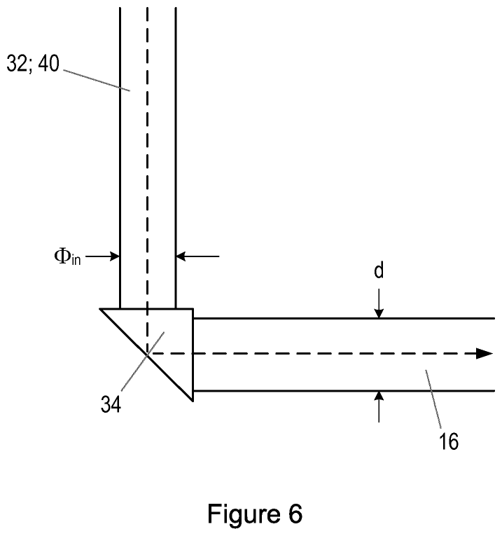

A light source 6 is provided in the hair cutting device 2 that generates laser light at one or more specific wavelengths. The light source 6 is optically coupled to the optical waveguide 4 so that the laser light generated by the light source 6 is coupled into the optical waveguide 4 (and specifically coupled into an end of the optical waveguide 4 so that the laser light propagates through the optical waveguide 4). Some exemplary arrangements for enabling light from light source 6 to be coupled into the optical waveguide 4 are described below with reference to FIGS. 5 and 6.

The light source 6 is configured to generate laser light at one or more specific wavelengths that can be used to cut or burn through hair. In particular, each wavelength corresponds to the wavelength of light absorbed by a chromophore that is found in hair. As is known, a chromophore is the part of a molecule that provides the molecule with its colour. Thus, the laser light will be absorbed by the chromophore and converted into heat which will melt or burn the hair or otherwise destroy the bonds in the molecules of the hair, and it is this melting or burning that provides the cutting action of the hair cutting device 2.

Suitable chromophores that can be targeted by the laser light generated by the light source 6 include, but are not limited to, melanin, keratin and water. Suitable wavelengths of laser light that can be used include, but are not limited to, wavelengths selected from the range 380 nm (nanometers) to 500 nm and 2500 nm to 3500 nm. Those skilled in the art will be aware of the wavelengths of light that are absorbed by these chromophores, and thus also the specific wavelengths of light that the light source 6 should generate for this purpose, and further details are not provided herein.

In some embodiments the light source 6 can be configured to generate laser light at a plurality of wavelengths (either simultaneously or sequentially), with each wavelength being selected to target a different type of chromophore. This can improve the cutting action of the optical waveguide 4 since multiple types of molecules in the hair may be burnt using the laser light. Alternatively multiple light sources 6 can be provided that each generate laser light at a respective wavelength, and each light source 6 can be coupled to a respective optical waveguide 4 to provide multiple cutting elements 4 in the device 2.

The hair cutting device 2 also comprises a control unit 8 that controls the operation of the hair cutting device 2, and in particular is connected to the light source 6 to control the activation and deactivation of the light source 6 (and in some embodiments control the wavelength and/or intensity of the light generated by the light source 6). The control unit 8 may activate and deactivate the light source 6 in response to an input from a user of the hair cutting device 2. The control unit 8 can comprise one or more processors, processing units, multi-core processors or modules that are configured or programmed to control the hair cutting device 2.

As noted above, FIG. 2 shows a hair cutting device 2 that is in the form of a handheld wet razor. FIG. 2 shows a side view and a bottom view of the razor 2. The razor 2 comprises a handle 10 for the subject (or other user of the device 2) to hold, and a head portion 12 that includes the cutting element 4 (optical waveguide/fibre). As shown, the optical waveguide 4 is arranged along an edge of the head portion, and a part of the optical waveguide 14 forms (or corresponds to) a cutting face 14. The cutting face 14 is the part of the optical waveguide 14 that is intended to come into contact with hair as the hair cutting device 2 is moved across the skin of the subject. A light source 6 and control unit 8 are shown as being incorporated into the head portion 12 and handle 10 respectively, but it will be appreciated that the positions of these components in the hair cutting device 2 as shown in FIG. 2 is not limiting. Likewise it will be appreciated that the hair cutting device 2 shown in FIG. 2 is merely an example, and the invention can be incorporated or used in any type of hair cutting device 2 that conventionally comprises a blade for physically cutting or slicing hair (whether the blade is static or actuated in order to achieve a cutting action).

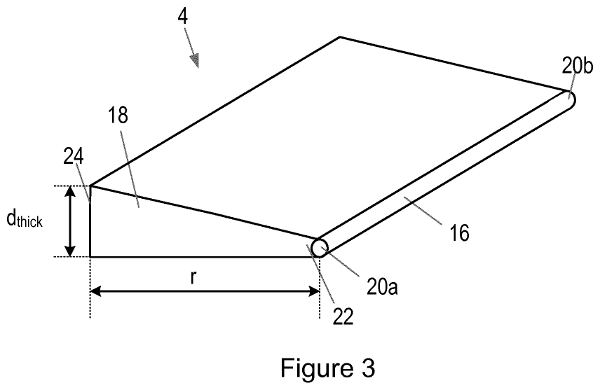

An optical waveguide 4 according to an embodiment of the invention is shown in FIG. 3. According to the invention, the optical waveguide 4 comprises a core 16 and a support structure 18. The support structure 18 is coupled to or otherwise in contact with the core 16 and supports the core 16 along the length of the core 16. The core 16 has an optical axis along the length of the core 16 that generally corresponds to the direction in which light that is coupled into a first end 20a of the core 16 propagates along the core 16 towards a second end 20b of the core 16. Part of the side of the core 16 is exposed along the length of the core 16 to form a cutting face 14. As described in more detail below, the support structure 18 can be formed from a cladding or other form of outer layer for the core 16.

In some embodiments the support structure 18 can have a cross-section with a thickness that generally tapers from a thin side 22 at which the support structure 18 couples to the core 16 to a thick side 24. The thickness of the support structure 18 can taper linearly or non-linearly from the thin side 22 to the thick side 24. Preferably the thickness of the thick side 24, d_{thick}, is much larger (e.g. by at least one order of magnitude) than the thickness of the thin side 22, dₜₕᵢₙ. The support structure 18 shown in FIG. 3 is an example of a support structure 18 with a thickness that tapers linearly from the thin end 22 to the thick end 24, and thus the support structure 18 is wedge- or V-shaped, and the core 16 is at an apex edge 22 of the support structure 18 (i.e. the core 16 is at the ‘thin’ side 22 of the wedge or V). In this way, a side of the core 16 is exposed to form the cutting face 14, while the rest of the core 16 is supported by support structure 18. In some embodiments, a predetermined amount of the circumference of the core 16 is exposed to form the cutting face 14 along the length of the core 16. In some embodiments, the predetermined amount of the circumference of the core 16 that is exposed to form the cutting face 14 is more than 10%, more preferably more than 20%, more preferably more than 30%, more preferably more than 40% or more preferably more than 50%. It will be appreciated that the amount of the circumference of the core 16 that is exposed can depend on the strength of the support structure 18; the stronger the support structure 18, the more of the circumference of the core 16 that can be exposed.

Thus, the optical waveguide 4 shown in FIG. 3 is much less fragile than an optical fibre that just comprises a core 16, or a core 16 with a standard layer of cladding. The support structure 18 is preferably strong enough to enable the optical waveguide 4 (optionally with other components) to be manually inserted into or attached to a hair cutting device 2 by a user and subsequently removed or detached from the hair cutting device 2 without the optical waveguide 4 breaking or being damaged. This strength can be achieved using materials that are typically used as cladding for a core 16. In addition, the overall shape of the waveguide 4 with the core 16 exposed on the thin side 22 of the support structure 18 means that the cutting face 14 is well exposed to hairs when the waveguide 4 is being used to cut hairs.

It will be appreciated that the wedge- or V-shaped support structure 18 shown in FIG. 3 is merely exemplary, and support structures 18 having other shapes could be used if desired, provided that the support structure 18 supports the core 16 along its length, and provides an optical waveguide 4 that is much less fragile than an optical fibre that just comprises a core 16, or a core 16 with a standard layer of cladding.

In some embodiments, the core 16 can have a diameter of between 5 μm and 100 μm, although a core 16 with a diameter outside this range can be used if required. In some embodiments, the thin side 22 of the support structure 18 that couples with the core 16 can have a similar thickness to the core 16 (i.e. the thickness of the thin side 22, dₜₕᵢₙ, is approximately the same as the diameter, d, of the core 16). Thus, in some embodiments the thickness of the thin side 22, dₜₕᵢₙ, can be between 5 μm and 100 μm.

In some embodiments, the thickness of the thick side 24, d_{thick}, can be between 0.1 mm and 2 mm, although it will be appreciated that other thicknesses can be used as required.

In some embodiments, the support structure 18 can extend a distance r from the core 16, and in some embodiments, distance r is much larger than the diameter d of the core 16 (for example larger by at least one order of magnitude). For example, in some embodiments the support structure 18 can extend from 1 mm to 10 mm from the core 16.

The core 16 and/or support structure 18 can be made from any suitable material or combination of materials. For example the core 16 and/or support structure 18 can be composed of or comprise any one or more of silica, fluoride glass, phosphate glass, chalcogenide glass, and/or crown glass (such as BK7).

As is known, the optical waveguide 4, and particularly the core 16, acts as a waveguide for the light coupled from the light source 6 through the occurrence of total internal reflection, since the refractive index of air is lower than that of the optical waveguide 4/core 16. However, if an object that has a refractive index higher than the core 16 is put into contact with the core 16, then the total internal reflection is ‘frustrated’ and light can couple from the core 16 into that object. Thus, in order for light to be coupled into a hair from the core 16 (to provide a cutting action), the core 16 must have the same or a lower refractive index than hair at the point at which the hair contacts the core 16. Thus, the core 16 must have the same or a lower refractive index than hair at least at the cutting face 14 portion of the core 16. Preferably the refractive index of the core 16 at the cutting face 14 is the same as that of hair since that provides the best coupling of light from the core 16 to the hair.

Thus, the refractive index of the core 16 at least at the cutting face 14 can be equal to or lower than 1.56. More preferably the refractive index of the core 16 at least at the cutting face 14 can be equal to or lower than 1.55. Even more preferably, the refractive index of the core 16 at least at the cutting face 14 can be equal to or lower than 1.54.

In some embodiments, a lower bound for the refractive index of the core 16 at the cutting face 14 can be 1.48, 1.51, 1.53 or 1.54.

A range of values from which the refractive index of the core 16 is selected can be formed from any combination of the upper and lower refractive index bounds set out in the preceding paragraphs.

The support structure 18 can act as a cladding for the core 16 (and, as described in more detail below, in some embodiments the support structure 18 can be formed from cladding for the core 16), and thus the support structure 18 is made or formed from a material that has a lower refractive index than the material used to make or form the core 16.

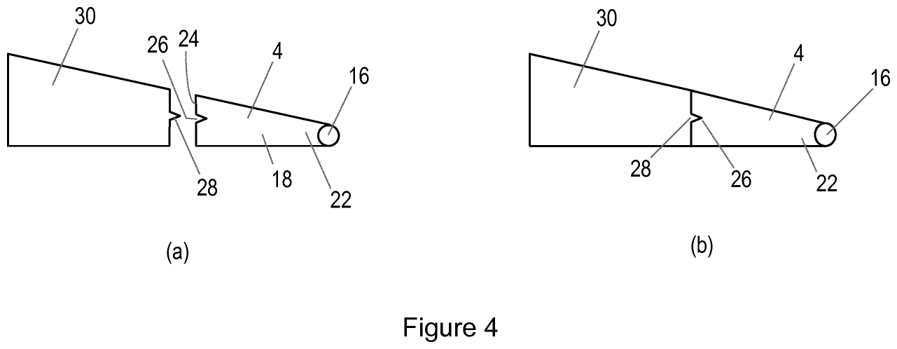

In some embodiments, to enable the attachment of the cutting element 4 to a hair cutting device 2, the support structure 18 can be shaped to receive, or be received in, a part of the hair cutting device 2 so that the cutting element 4 is held in place in the hair cutting device 2. Alternatively, or in addition, to enable the correct alignment of the cutting element 4 with a hair cutting device 2 (and particularly a light source 6 of the hair cutting device 2), the support structure 18 can be shaped in a way that enables the cutting element 4 to be correctly aligned with the hair cutting device 2. In both cases, the support structure 18 can comprise one or more protrusions or indentations that are configured to cooperate with corresponding protrusions or indentations on the body of the hair cutting device 2. For example, as shown in FIG. 4, an indentation 26 can be formed in the thick side 24 of the support structure 18, and there can be a corresponding protrusion 28 on a face 29 of a body 30 of the hair cutting device 2. It will be appreciated that although the body 30 of the hair cutting device 2 is shown as having a thickness that tapers in a similar way to the cutting element 4, this is not required and the body 30 can have any suitable shape.

In addition, although not shown in FIG. 4, it will be appreciated that the body 30 and/or the cutting element 4 can comprise one or more components, for example one or more clips, resilient components, fastenings, etc., that enable the cutting element 4 to be held in place in the hair cutting device 2 and removed, for example for cleaning or replacement.

FIG. 5 illustrates two ways in which light from a light source 6 in the hair cutting device 2 can be coupled into core 16 of the cutting element 4. In a first embodiment, shown in FIG. 5(a), light from the light source 6 can be coupled into the first end 20a of the core 16 via an optical fibre 32 (or other type of optical waveguide) and a prism 34 (or other type of light reflecting component). The use of prism 34 provides a compact arrangement for coupling the light into the core 16. A second prism 36 (or other type of light reflecting component) can be provided at the second end 20b of the core 16 for coupling light that has passed through the core 16 into a second optical fibre 38. The second prism 36 and second optical fibre 38 remove light from the cutting element 4 (which is close to the skin of the subject) in order to avoid the cutting element 4 being heated by the light. It will be appreciated that alternative structures can be used for this purpose, and the structure used can depend on the power of the light source 6 and whether the heat is spread evenly in the cutting element 4. In some embodiments, the light in the second optical fibre 38 can be monitored to determine the health/status of the optical waveguide 4, and/or the operation of the hair cutting device 2.

In some embodiments, which are not shown in FIG. 5, it may be possible for the optical fibre 32 to connect directly to the first end 20a of the core 16, and thus the prism 34 can be omitted. Alternatively or in addition, it may be possible for optical fibre 38 to connect directly to the second end 20b of the core 16, and thus the prism 36 can be omitted.

In the second embodiment shown in FIG. 5(b), a first light guide 40 can be provided between the first optical fibre 32 and the prism 34 to improve the coupling of light from the light source 6 to the core 16. Likewise, a second light guide 42 can be provided between the prism 36 and the second optical fibre 38 to improve the coupling of light from the core 16 to the second optical fibre 38. The first light guide 40 can be provided with a lens or other optical element at the coupling with the first optical fibre 32 for focusing the light from the light source 6 into the first light guide 40.

FIG. 6 illustrates a preferred arrangement of the coupling between the light source 6 and the core 16. In particular, to reduce or avoid power loss, the diameter Φᵢₙ of the first optical fibre 32 (in the FIG. 5(a) embodiment) or the first light guide 40 (in the FIG. 5(b) embodiment) is less than the diameter d of the core 16. To reduce or avoid power loss in the coupling from the core 16 to the second optical fibre 38 or the second light guide 42, the diameter of the second optical fibre 38 or the second light guide 42 should be larger than the diameter d of the core 16.

In some embodiments, instead of a direct coupling between first optical fibre 32 and the prism 34 or the core 16, the first optical fibre 32 can emit a free optical beam towards the prism 34 or the core 16. In this case, one or more lenses or other optical components can be provided to focus the free space optical beam towards the prism 34 of the core 16.

In some embodiments, the hair cutting device 2 is configured to follow the contours of the body of the subject to improve the closeness of the hair cutting action. In these embodiments, the cutting element 4 can be configured to move relative to a handle 10 of the hair cutting device 2 so that the cutting element 4 is able to follow the contours. The contour-following cutting element 4 can be situated at a point where a free space light beam is bent through 90 degrees. In a preferred embodiment this bending will be caused by a first mirror placed after the light source 6 and before a lens.

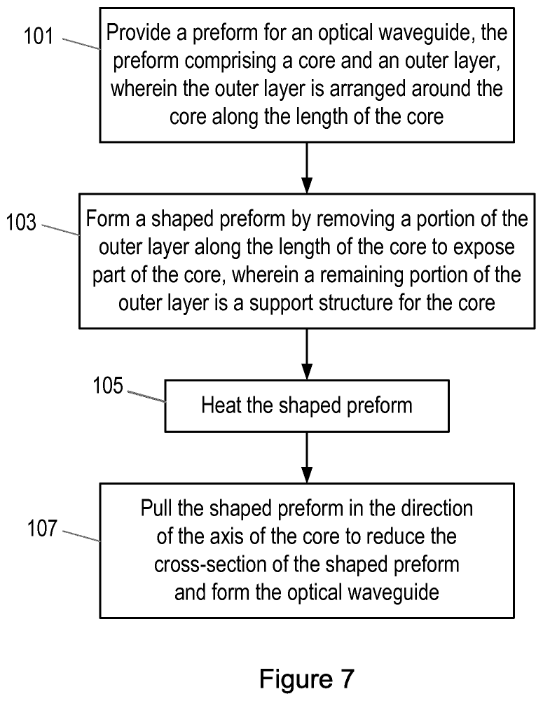

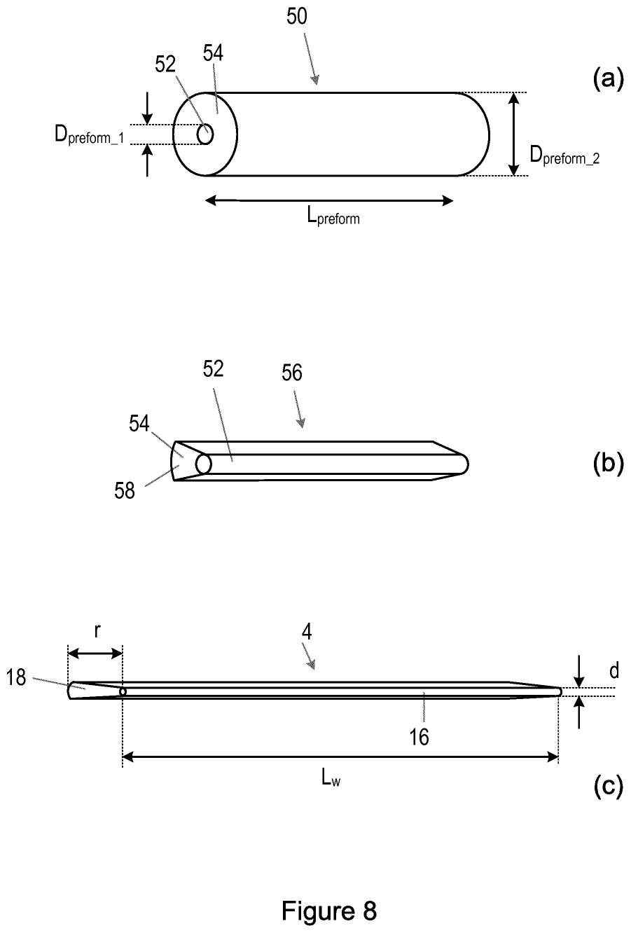

FIG. 7 is a flow chart that shows a method of manufacturing a cutting element 4 according to the invention. The steps in the method of FIG. 7 are illustrated with reference to FIG. 8.

In conventional manufacturing techniques, a standard optical fibre goes through several processing techniques (such as etching, coating, etc.) to obtain its final shape. However processing sub-millimetre diameter fibre is very difficult since the fibre is fragile and requires high precision. The manufacturing method described herein overcomes these problems.

In a first step, step 101, a preform 50 for an optical waveguide 4 is provided. The preform 50 comprises a core 52 and an outer layer 54 that surrounds the core 52 along the length of the core 52. The preform 50 can be made using conventional techniques for making preforms for optical waveguides.

The core 52 and/or outer layer 54 can be made from any suitable material or combination of materials. For example the core 52 and/or outer layer 54 can be composed of or comprise any one or more of silica, fluoride glass, phosphate glass, chalcogenide glass, and/or crown glass (such as BK7). More generally, the material(s) used to form the core 52 should have low absorption of light at the wavelengths used in the hair cutting device 2, a high glass transition temperature Tg and a refractive index that is higher than the material used to form the outer layer 54.

The material forming the core 52 preferably has a higher refractive index than the material forming the outer layer 54. The refractive index of the core 52 can be as described above with reference to the core 16 in the embodiment shown in FIG. 3.

The use of preforms in manufacturing optical fibres is well-known in the art, and thus those skilled in the art will be aware of various techniques that can be used to form a preform 50 having the structure shown in FIG. 8(a).

The preform 50 has a length L_{preform}, the core 52 has a diameter D_{preform_1} and the outer layer 54 has a diameter D_{preform_2}. Typically a preform for an optical waveguide 4 can be a rod with a diameter (D_{preform_2}) between 1 and 10 cm and length L_{preform} of around 1 m.

After the preform 50 is formed, the preform 50 is shaped to form a shaped preform 56 (step 103). In particular, the preform 50 is shaped so that it has the cross-section desired for the optical waveguide 4. For example the preform 50 can be shaped so that it has a cross-section corresponding to the optical waveguide 4 shown in FIG. 3. FIG. 8(b) illustrates an exemplary shaped preform 56.

In step 103 a part or portion of the outer layer 54 is removed along the length of the core 52 to expose part of the core 52. The exposed part of the core 52 will form the cutting face 14 of the core 16 in the completed optical waveguide 4. The part or portion of the outer layer 54 remaining after step 103 is referred to as the remaining portion 58 of the outer layer 54, and this remaining portion 58 will form the support structure 18 in the completed optical waveguide 4.

Step 103 can comprise grinding and/or polishing the outer layer 54 to remove parts or portions of the outer layer 54. Alternatively, step 103 can comprise using chemical etching or laser ablation to remove parts or portions of the outer layer 54. Step 103 can comprise one or more separate grinding and/or polishing processes in order to obtain the shaped preform 56.

In some embodiments, the step of shaping the preform 50 comprises removing a portion of the outer layer 54 so that the remaining portion 58 of the outer layer 54 and the core 52 is wedge- or V-shaped as shown in FIG. 3, with the core 52 at an apex of the wedge or V.

In some embodiments, the step of shaping the preform 50 can comprise removing a portion of the outer layer 54 along the length of the core 52 such that a predetermined or required amount of the circumference of the core 52 is exposed along the length of the core 52. The predetermined or required amount of the circumference of the core 16 that is exposed to form the cutting face 14 is more than 10%, more preferably more than 20%, more preferably more than 30%, more preferably more than 40% or more preferably more than 50%. It will be appreciated that the amount of the circumference of the core 16 that is exposed can depend on the strength of the support structure 18 in the optical waveguide resulting from the preform 50; the stronger the support structure 18, the more of the circumference of the core 16 that can be exposed.

After shaping the preform 50, the shaped preform 56 is heated (step 105). The shaped preform 56 is heated to a temperature sufficient to enable the shaped preform 56 to be pulled in the direction of the axis of the core 52 to form the final waveguide 4. In particular the shaped preform 56 is heated to a temperature above the glass transition temperature Tg for the material forming the shaped preform 56. The pulling process (step 107) increases the length of the shaped preform 56 (in some cases by two or three orders of magnitude) and reduces the size of the cross-section of the shaped preform 56. The pulling process reduces the cross-section of the shaped preform 56 generally linearly so that the final waveguide 4 has a similar shape cross-section to the shaped preform 56.

After the shaped preform 56 is pulled to produce a waveguide 4 with a cross-section of the required size, the waveguide 4 can be cooled and the waveguide 4 cut to an appropriate length for use in a hair cutting device 2. It will be appreciated therefore that a single preform 50 can be used to create many (e.g. several hundred or several thousand) cutting elements 4.

An exemplary final waveguide 4 that has been cut to a suitable length for use in a hair cutting device 2 is shown in FIG. 8(c). The waveguide has a length L_{w}, the core 16/52 has a diameter d (which can correspond to the exemplary core diameters mentioned above with reference to the embodiment shown in FIG. 3), and the outer layer 54/support structure 18 has a depth r (which can also correspond to the exemplary support structure dimensions mentioned above with reference to the embodiment shown in FIG. 3). A typical length, L_{w}, of the optical waveguide 4 in a hair cutting device 2 is around 3 cm, although it will be appreciated that other lengths can be used.

The heating and pulling processes (steps 105 and 107) are generally conventional, and those skilled in the art will be aware of various ways in which they can be implemented, and no further details are provided herein.

It will be appreciated that the steps of heating (step 105) and pulling (step 107) will be performed at generally the same time (i.e. the shaped preform 56 is heated and then pulled).

It will be appreciated that since the shaping process (step 103) is performed on the preform 50, which is much larger than the optical waveguide 4, and then the shaped preform 56 is then pulled to form the optical waveguide 4, the shaping process does not require as high precision as those performed on an optical waveguide after pulling (since the pulling process itself acts to smooth out imperfections in the shaping process). For example, grinding or polishing the preform 50 might leave scratches or defects in the surface of the shaped preform 56, but these imperfections are de-magnified (i.e. smoothed out) by the heating and pulling processes and only leave small imperfections or defects in the final optical waveguide 4 that have little influence on the performance of the optical waveguide 4.

Further advantages of performing the shaping process (step 103) on the preform 50 is that due to the dimensions of the preform 50 it is much more likely to be able to withstand the stresses and strains involved in the shaping process, and it is much easier to shape the preform 50 so that the core 52 is exposed, and even to remove the outer layer 54 around a significant part of the circumference of the core 52.

In some embodiments, the outer layer 54 of the preform 50 can be further shaped to enable attachment of the cutting element 4 to, and/or alignment of the cutting element 4 with, a hair cutting device 2. Shaping the outer layer 54 in this way can comprise shaping the outer layer 54 to comprise one or more protrusions and/or indentations. This step can comprise grinding and/or polishing the outer layer 54.

Alternatively the optical waveguide 4 can be shaped (for example to include one or more protrusions and/or indentations) to enable attachment of the cutting element 4 to, and/or alignment of the cutting element 4 with, a hair cutting device 2 after the heating and pulling processes have been performed. This step can comprise grinding and/or polishing the support structure 18.

There is therefore provided an improved cutting element for use in a hair cutting device, and an improved method of manufacturing a cutting element.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage.

Any reference signs in the claims should not be construed as limiting the scope.

1. A method of manufacturing a cutting element for use in a hair cutting device, the cutting element comprising an optical waveguide, the method comprising:
providing a preform for an optical waveguide, the preform comprising a core and an outer layer, wherein the outer layer is arranged around the core along the length of the core;
forming a shaped preform by removing a portion of the outer layer along the length of the core to expose part of the core, wherein a remaining portion of the outer layer is a support structure for the core;
heating the shaped preform;
pulling the shaped preform in the direction of the axis of the core to reduce the cross-section of the shaped preform and form the optical waveguide; and
wherein the thickness of the support structure tapers linearly or non-linearly from a thin side at which the support structure contacts the core to a thick side that is distant from the core.

2. A method as claimed in claim 1, wherein the step of forming the shaped preform comprises grinding or polishing the preform to remove the portion of the outer layer.

3. A method as claimed in claim 1, wherein the thickness of the support structure tapers such that the support structure is wedge-shaped, and wherein the core is along an apex edge of the support structure.

4. A method as claimed in claim 1, wherein the thickness of the support structure tapers such that the support structure is V-shaped, and wherein the core is at the apex of the V-shaped support structure.

5. A method as claimed in claim 1, wherein the step of forming the shaped preform comprises removing the portion of the outer layer along the length of the core such that a predetermined amount of the circumference of the core is exposed along the length of the core.

6. A method as claimed in claim 5, wherein the predetermined amount of the circumference of the core is more than 20%, optionally more than 30%, optionally more preferably more than 40% or optionally preferably more than 50%.

7. A method as claimed in claim 1, further comprising the step of shaping the support structure to enable attachment of the cutting element to, and/or alignment of the cutting element with, a hair cutting device.

8. A method as claimed in claim 7, wherein the step of shaping the support structure comprises shaping the support structure to comprise one or more protrusions and/or indentations.

9. A cutting element for use in a hair cutting device, the cutting element comprising:
an optical waveguide comprising a core and a support structure, wherein the support structure contacts the core along the length of the core to support the core, and wherein part of the core is exposed along the length of the core to form a cutting face for contacting hair, wherein the thickness of the support structure tapers linearly or non-linearly from a thin side at which the support structure contacts the core to a thick side that is distant from the core.

10. A cutting element as claimed in claim 9, wherein the thickness of the support structure tapers such that the support structure is wedge-shaped and the core is at an apex edge of the support structure.

11. A cutting element as claimed in claim 9, wherein the thickness of the support structure tapers such that the support structure is V-shaped and the core is at the apex of the V-shape.

12. A cutting element as claimed in claim 9, wherein a predetermined amount of the circumference of the core is exposed to form the cutting face along the length of the core.

13. A cutting element as claimed in claim 12, wherein the predetermined amount of the circumference of the core is more than 20%, optionally more than 30%, optionally more preferably more than 40% or optionally preferably more than 50%.

14. A cutting element for use in a hair cutting device manufactured according to the method of claim 1.
